(19) United States
(12) Patent Application Publication
(10) Pub. No.: US 2018/0251381 A1
(43) Pub. Date: Sep. 6, 2018

(54) Polycrystalline Oxide Having Improved Grain Boundary Proton Conductivity

(71) Applicant: Korea Advanced Institute of Science and Technology, Daejeon (KR)

(72) Inventors: Sung-Yoon Chung, Daejeon (KR); Hyesung Kim, Daejeon (KR)

(21) Appl. No.: 15/725,847

(22) Filed: Oct. 5, 2017

(30) Foreign Application Priority Data
Mar. 3, 2017 (KR) 10-2017-0027441

(51) Int. Cl. C01F 11/02; C01G 25/00; C01G 25/02; C01G 99/00; H01M 8/1246

(52) U.S. Cl. CPC C01F 11/02; C01G 25/006; C01G 25/02; C01P 2006/40; H01M 8/1246; C01P 2002/36; C01G 99/006

(57) ABSTRACT

Provided is a polycrystalline oxide having a chemical formula such as the following A₁₋ₓB_{1-y}M_{y}O₃ and having an improved grain boundary proton conductivity as an oxide having a perovskite structure. Through the present invention, the conductivity and chemical stability of proton conducting oxide may be improved.

### CROSS-REFERENCE TO RELATED APPLICATION

This application claims priority to Korean Patent Application No. 10-2017-0027441 filed Mar. 3, 2017, the disclosure of which is hereby incorporated in its entirety by reference.

### TECHNICAL FIELD

The present invention relates to a polycrystalline oxide having improved grain boundary proton conductivity, and more particularly, to a polycrystalline oxide, which removes an amorphous layer present at the grain boundary and facilitates movement of protonic defects by adjusting the composition.

### BACKGROUND ART

A solid oxide fuel cell (SOFC) is composed of a structure in which a solid electrolyte is disposed between two electrodes (a fuel electrode and an air electrode). Hydrogen injected into a fuel electrode is separated into a hydrogen ion and two electrons, and the electrons move to an air electrode through an external circuit. In the air electrode, oxygen injected and electrons entering through the external circuit meet with each other and are separated into oxygen ions, and then the oxygen ions move toward the fuel electrode through a solid electrolyte. The moved oxygen ions are reacted with the hydrogen ions in the fuel electrode to form water which is a final byproduct.

The SOFC has various advantages such as ability to use various fuels together with eco-friendly characteristics in which water is produced as a reaction byproduct and a high energy conversion efficiency. However, the thermal deformation of a material occurring due to the high operation temperature (800° C. to 1,000° C.), low durability, and a late start-up time demand that a fuel cell be developed in a direction that lowers the operation temperature. In order to lower the high operation temperature, studies on a proton conducting solid oxide fuel cell (proton ceramic fuel cell, PCFC) using protonic defects which exhibit high mobility even at low temperature instead of oxygen ions have been actively conducted.

The PCFC may effectively decrease low durability and thermal deformation of a material, and the like, which were problems in the SOFC through a low operation temperature between 400° C. and 600° C. Further, unlike the SOFC, hydrogen injected into the fuel electrode is ionized, and then immediately moves to the air electrode through the electrolyte, so that water produced as a byproduct is produced not from the fuel electrode, but from the air electrode. The SOFC needs an additional process for separating hydrogen ions and water vapor by using a condenser in order to reuse hydrogen used in the fuel electrode, whereas the PCFC does not need the additional process, and thus has an advantage in that process costs may be reduced.

As a solid electrolyte used in the PCFC, a perovskite material is generally used. Perovskite is originally a mineral name of CaTiO₃, and many oxides having an ABO₃ form being a crystal structure which is the same as CaTiO₃ are generally collectively referred to as perovskite type oxides.

Among perovskite oxides used as an electrolyte of PCFC, BaCeO₃ oxide is known as a PCFC electrolyte material which has drawn the most attention due to a relatively high proton conductivity and a low sintering temperature (˜1,400° C.). However, the high grain boundary resistance and the low chemical stability have been continuously brought up as a problem to be solved. The grain boundary refers to two crystal boundaries having the same structure in a polycrystalline material of a metal or an alloy, but having different directions.

In order to solve the problems, studies for increasing the proton conductivity and the chemical stability by adjusting the composition of the material, such as addition of Ce together with Zr to the B-site (Ryu, K. H. & Haile, S. M., Solid State Ionics 125, 355-367 (1999)) and substitution of Ba with Sr at the A-site (Hung, I. M. et al., Journal of Power Sources 193, 155-159 (2009)) have been continuously conducted, but the effects thereof have been still insufficient.

### SUMMARY OF THE INVENTION

The present invention has been made in an effort to solve the aforementioned problems of the related art, and has a subject to remove an amorphous layer present at the grain boundary by adjusting the composition.

An exemplary embodiment of the present invention provides a polycrystalline oxide having an improved grain boundary proton conductivity, which exhibits high chemical stability even under an environment of water and carbon dioxide.

Another exemplary embodiment provides a polycrystalline oxide having a chemical formula such as the following A₁₋ₓB_{1-y}M_{y}O₃ and having an improved grain boundary proton conductivity as an oxide having a perovskite structure.

A may be any one element selected from barium (Ba) and strontium (Sr), or a mixture to which these elements are added.

B may be any one element selected from cerium (Ce), zirconium (Zr), and praseodymium (Pr), or a mixture thereof.

M may be any one element selected from scandium (Sc), gallium (Ga), yttrium (Y), indium (In), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu) or a mixture thereof.

Yet another exemplary embodiment provides a polycrystalline oxide having a grain boundary structure in which an amorphous layer is removed.

Still another exemplary embodiment provides a polycrystalline oxide having a barrier energy (activation energy) value of 0.65 eV or more caused by proton conduction.

Still yet another exemplary embodiment provides a polycrystalline oxide having a proton conductivity of 7×10⁻³ S/cm or more at 500° C.

A further exemplary embodiment provides a polycrystalline oxide including BaCO₃ in an amount of less than 3% when being reacted with carbon dioxide or water.

According to exemplary embodiments of the present invention, it is possible to describe the effects of the polycrystalline oxides as follows.

According to at least one of exemplary embodiments of the present invention, the conductivity and chemical stability of protonic defects may be improved by removing the grain boundary amorphous layer.

However, the effects which the polycrystalline oxides according to exemplary embodiments of the present invention can achieve are not limited to those mentioned above, and the other effects not mentioned will be clearly understood by a person with ordinary skill in the art to which the present invention pertains from the following description.

### BRIEF DESCRIPTION OF THE DRAWINGS

The accompanying drawings included as a part of the detailed description to assist understanding of the present invention provide exemplary embodiments of the present invention and explain the technical spirit of the present invention along with the detailed description.

FIG. 1 is a schematic view illustrating a procedure in which the amorphous layer present at the grain boundary is removed by a method of adjusting the composition according to the present invention.

FIGS. 2A and 2B are scanning transmission electron microscope (STEM) images measured in the [100] projection direction of a polycrystalline oxide in which 10 mol % of Dy as an acceptor is added to an ABO₃-type perovskite structure having a composition of 1:1:3.

FIGS. 3A and 3B are scanning transmission electron microscope images measured in the [100] projection direction of a polycrystalline oxide in which 10 mol % of Dy as an acceptor is added to an ABO₃-type perovskite structure having a composition of 0.95:1:3 by adjusting the composition.

FIGS. 4A, 4B, 4C, and 4D are graphs illustrating the impedance results exhibiting an effect of decreasing the resistance of the grain boundary, which is measured in Example 1.

FIGS. 5A, 5B, 5C, and 5D are Arrhenius graphs illustrating an effect of decreasing the barrier energy analyzed before and after adjusting the composition in Analysis Example 2.

FIGS. 6A, 6B, 6C, and 6D are graphs illustrating XRD results measured after a chemical stability test of the polycrystalline oxides whose composition is adjusted, in materials to which 10 mol % of Dy, Gd, Sm, and Y are added, respectively with respect to CO₂.

FIGS. 7A, 7B, 7C, and 7D are graphs illustrating XRD results measured after a chemical stability test of the oxides whose composition is adjusted and is not adjusted, in materials to which 10 mol % of Dy, Gd, Sm, and Y are added, respectively with respect to H₂O.

FIG. 8 illustrates the impedance result of a polycrystalline oxide whose composition is adjusted, to which 10 mol % of Sm is added, measured at 500° C.

### DETAILED DESCRIPTION

The terms or words used in the present specification and the claims should not be construed as being limited as typical or dictionary meanings, and should be construed as meanings and concepts conforming to the technical spirit of the present invention on the basis of the principle that an inventor can appropriately define concepts of the terms in order to describe his or her own invention in the best way. Accordingly, since the exemplary embodiments described in the present specification and the configurations illustrated in the drawings are only the most preferred exemplary embodiment of the present invention and do not represent all of the technical spirit of the present invention, it is to be understood that various equivalents and modified embodiments, which may replace these exemplary embodiments and configurations, are possible at the time of filing the present application. Hereinafter, a polycrystalline oxide having improved grain boundary proton conductivity according to an exemplary embodiment of the present invention will be described in detail with reference to accompanying drawings.

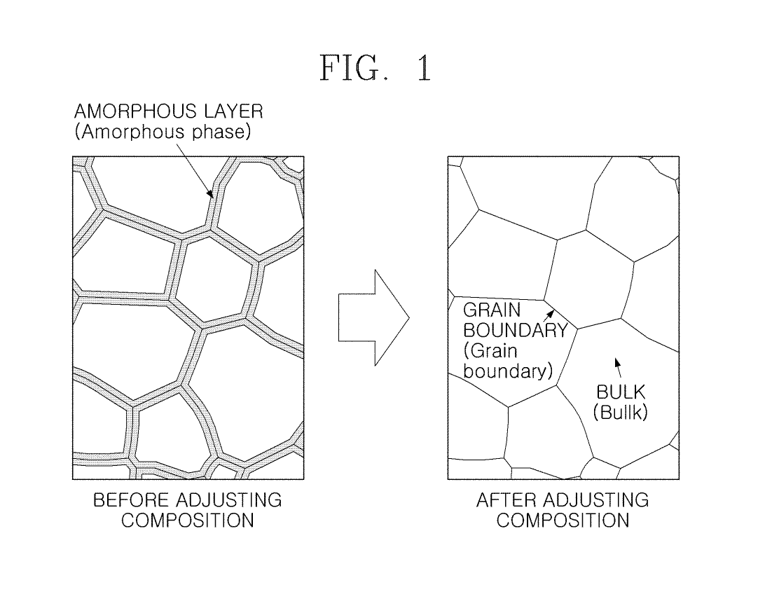

FIG. 1 is a schematic view illustrating a procedure in which the amorphous layer present at the grain boundary is removed by a method of adjusting the composition according to the present invention. Protonic defects moving between oxygen atoms through the Grotthuss mechanism have a decreased mobility in a region in which the continuity of oxygen is decreased as in the amorphous layer. In a proton conductor having a general ABO₃-type perovskite structure, an amorphous layer is present at the grain boundary, but until now, there has been no study which suggests a solution to these problems. The present invention effectively removed an amorphous layer present at the grain boundary by adjusting the composition, and as a result, obtained an effect in which the proton conductivity is improved. Through FIG. 1, the problem to be solved by the present invention can be easily understood.

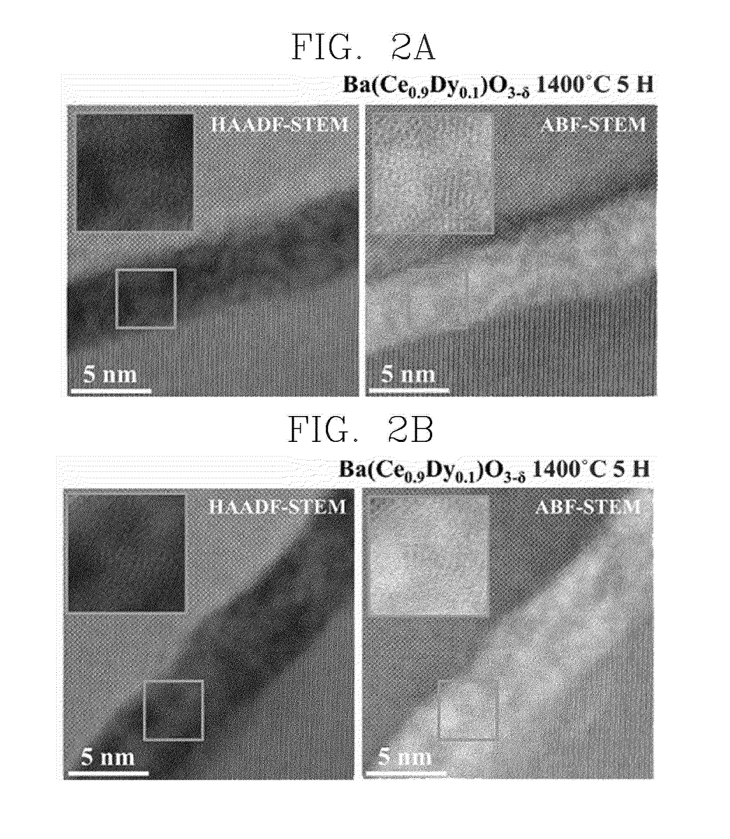

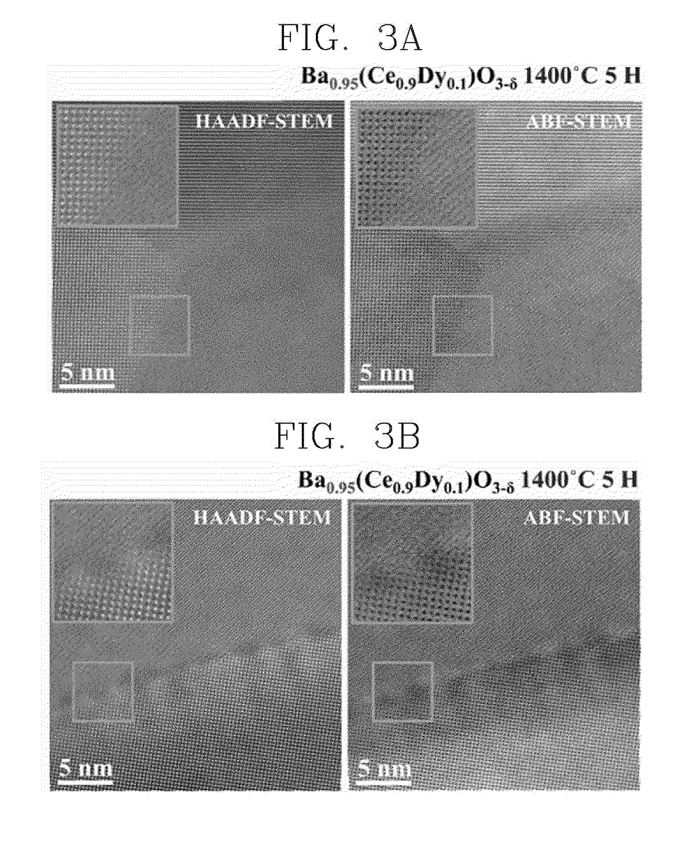

FIGS. 2A and 2B are scanning transmission electron microscope (STEM) images measured in the [100] projection direction of a polycrystalline oxide in which 10 mol % of Dy as an acceptor is added to an ABO₃-type perovskite structure having a composition of 1:1:3, and FIGS. 3A and 3B are scanning transmission electron microscope images measured in the [100] projection direction of a polycrystalline oxide in which 10 mol % of Dy as an acceptor is added to an ABO₃-type perovskite structure having a composition of 0.95:1:3 by adjusting the composition. The present invention will be described with reference to FIGS. 2 and 3.

The present invention removed an amorphous layer present at the grain boundary by changing the composition ratio of A-site atoms in a polycrystalline oxide having an ABO₃-type perovskite structure, and as a result, an object thereof is to improve the proton conductivity and chemical stability.

Perovskite used as a proton conducting solid electrolyte is produced as the A site, the B site, and the M site are doped with an element having a valence of 2+, an element having a valence of 4+, and finally, an acceptor having a valence of 3+, respectively.

The perovskite can be expressed as a chemical formula such as A₁₋ₓB_{1-y}M_{y}O₃, A may be any one element selected from barium (Ba) and strontium (Sr) or a mixture to which the elements are added, and B may be any one element selected from cerium (Ce), zirconium (Zr), and praseodymium (Pr) or a mixture thereof.

M (that is, an acceptor) may be any one element selected from scandium (Sc), gallium (Ga), yttrium (Y), indium (In), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu) or a mixture thereof.

In the present invention, a BaCeO₃ system was selected as a perovskite structure to which an acceptor is added, and a synthesis was carried out with a general composition having 1.0 mol of Ba and a composition in which Ba is insufficient by 0 mol to 0.1 mol. It was confirmed that as compared to the former, a perovskite oxide synthesized with a latter composition is characterized by being present as a solid single phase without any phase decomposition even in a high-temperature sintering process.

Meanwhile, in the BaCeO₃ oxide having a perovskite structure to which the acceptor is added, Ba may include any one element selected from Sr, Ca, and La or a mixture to which a portion of these elements are added, but is not limited thereto.

Referring to FIGS. 2A and 2B, it can be confirmed that an amorphous layer amounting to several nanometers (nm) is present at the grain boundary.

In order to directly confirm the effects of the present invention, it is necessary to confirm that the amorphous layer is removed through an atomic unit analysis. Further, there is a need for a procedure to prove an effect in which a method of adjusting a composition suggested by the present invention improves the proton conductivity by comparing a resistance value of a BaCeO₃ oxide made through the change in composition suggested by the present invention with that of a BaCeO₃ oxide made by a general method.

For this purpose, each resistance value was confirmed by using a high-angle annular dark field (HAADF) being an electron microscopy technique capable of performing an atomic unit analysis, an annular bright field (ABF) scanning transmission electron microscopy (STEM) apparatus, and an impedance analysis method (electrochemical impedance spectroscopy) capable of measuring the resistances in the bulks and at the grain boundaries by dividing the resistances according to the frequency region. Further, it was confirmed whether the removal of the amorphous layer at the grain boundary actually decreased the barrier energy by obtaining the barrier energy (activation energy) value when passing through the grain boundary by using a resistance value obtained through the impedance analysis method. The details will be described in detail through the Example, the Test Examples, and the Analysis Example described below.

### (Example 1) (Production of Sintered Body)

Example 1 will describe a method for preparing an oxide having an adjusted composition of an A-site atom for improving the proton conductivity in a polycrystalline oxide having a perovskite structure, to which an acceptor having a valence of 3+ is added.

In order to prepare a polycrystalline oxide having a perovskite structure, to which an acceptor having an exactly adjusted composition is added, it is preferred to use a solid-phase synthesis method (solid-state reaction). However, the polycrystalline oxide may also be prepared by one or more methods selected from the group consisting of a sol-gel method, a physical vapor deposition (PVD) method, a chemical vapor deposition (CVD) method, a molecular beam epitaxy (MBE) method, and a vacuum deposition method (thermal evaporation).

The solid-phase synthesis method is usually used because the method may exactly adjust the composition of a polycrystalline oxide having a perovskite structure, to which an acceptor is added, may obtain high reproducibility at a low price, and easily mass-produces the polycrystalline oxide.

When a polycrystalline oxide is prepared by the solid-phase synthesis method, barium carbonate (BaCO₃), cerium oxide (CeO₂), and a powder in the form of an oxide (M₂O₃) of an acceptor each having a valence of 3+ are mixed at a suitable ratio, the mixture is ball milled, and then an uniaxial pressing and a cold isostatic pressing (CIP) are performed through a square mold to form a molded body having a square shape. Thereafter, a hard sintered body is formed through sintering at 1,400° C. for 5 hours. A preferred sintering temperature may be 1,300° C. to 1,600° C.

### (Analysis Example 1) (Electron Microscopic Analysis)

Analysis Example 1 will suggest a result in which an amorphous layer structure is directly observed at an atomic unit at the grain boundary of barium cerate (BaCe_{0.9}Dy_{0.1}O_{3-δ}) to which 10 mol % of Dy is added as an acceptor and barium cerate (Ba_{0.95}Ce_{0.9}Dy_{0.1}O_{3-δ}) to which the same amount of the same acceptor is added and in which only the composition of Ba is adjusted among hydrogen ion conductive polycrystalline oxides. Hereinafter, an atomic unit analysis is performed to know whether an amorphous layer is produced at the grain boundary of a perovskite polycrystalline oxide generated by adjusting the composition of Ba.

A sample for observation by an electron microscope used barium cerate to which an acceptor is added, which is manufactured by a general solid-phase synthesis method as in the method shown in Example 1. In order to confirm the effects of the composition adjustment on the grain boundary conductivity, a sample of a barium cerate oxide to which 10 mol % of Dy was added as an acceptor and a sample of a barium cerate oxide in which the composition of barium (Ba) was adjusted were each manufactured according to a typical polycrystal transmission electron microscopic sample manufacturing method. Two polycrystal samples were polished to a thickness of 100 μm, and then was ultrasonically cut by a disc having a diameter of 3 mm. The disc sample was dimpled, and then was thinly manufactured such that the specimen could be finally observed by a scanning transmission electron microscope through ion-milling.

The HAADF-STEM method shows a contrast of an image according to the atomic number, and makes crystal lattices be differentiated by atomic units because a heavy atom, that is, a high atomic number exhibits a bright contrast. In contrast, the ABF-STEM method is a good method to confirm the position of an atom such as oxygen having a low atomic number, and obtains an image by taking electrons in a region (10 to 20 mrad) in which the scattering angle is low by using the fact that a heavy atom is more scattered than a light atom, and makes the position of the light atom an image through the obtained image.

When the two transmission electron microscope techniques are utilized, there is an advantage in that it can be directly confirmed whether there is an amorphous layer present at the grain boundary. It can be expected that an amorphous layer having a higher oxygen ratio than a crystalline layer may be displayed as a dark region in the HAADF-STEM mode, and may be displayed as a bright region in the ABF-STEM mode.

FIGS. 2A and 2B are a STEM lattice image in the [100] direction obtained by using the HAADF-STEM mode and the ABF-STEM mode of BaCe_{0.9}Dy_{0.1}O_{3-δ}. Further, FIGS. 3A and 3B are STEM lattice image in the [100] direction obtained by using the HAADF-STEM mode and the ABF-STEM mode of Ba_{0.95}Ce_{0.9}Dy_{0.1}O_{3-δ}. Since the atomic numbers of Ba (atomic number: 56), Ce (atomic number: 58), and Dy (atomic number: 66) are not significantly different from each other, the position of each atom is not easily spotted in the bulk. However, oxygen (O, atomic number: 8) has a small atomic number, and thus has an advantage in that oxygen can be easily differentiated through the ABF-STEM mode.

It can be seen that a portion shown as black in a blue square portion in the HAADF-STEM image in FIG. 2A is shown to be bright in the ABF-STEM image in FIG. 2A. The observation means that the inside is composed of an amorphous layer including an element having a low atomic number such as oxygen instead of a hollow space. Meanwhile, as a result of measurement, it was confirmed that the thickness was about 5 nm.

In contrast, when the blue square images of the HADF-STEM image and the ABF-STEM image in FIG. 3A are compared with each other, it can be confirmed that neat grain boundary images are equally exhibited. The confirmation indicates that the grain boundary has a grain boundary structure having no amorphous layer.

The images in FIG. 2B and FIG. 3B are HAADF-STEM and ABF-STEM images additionally measured before and after adjusting the composition, and are results measured in various regions in order to solve the biggest disadvantage of an electron microscope which is restricted to a local region image. As can be confirmed from the result, it can be seen that the phenomenon is not a phenomenon restricted to a local region, but a phenomenon commonly occurring throughout the entire sample.

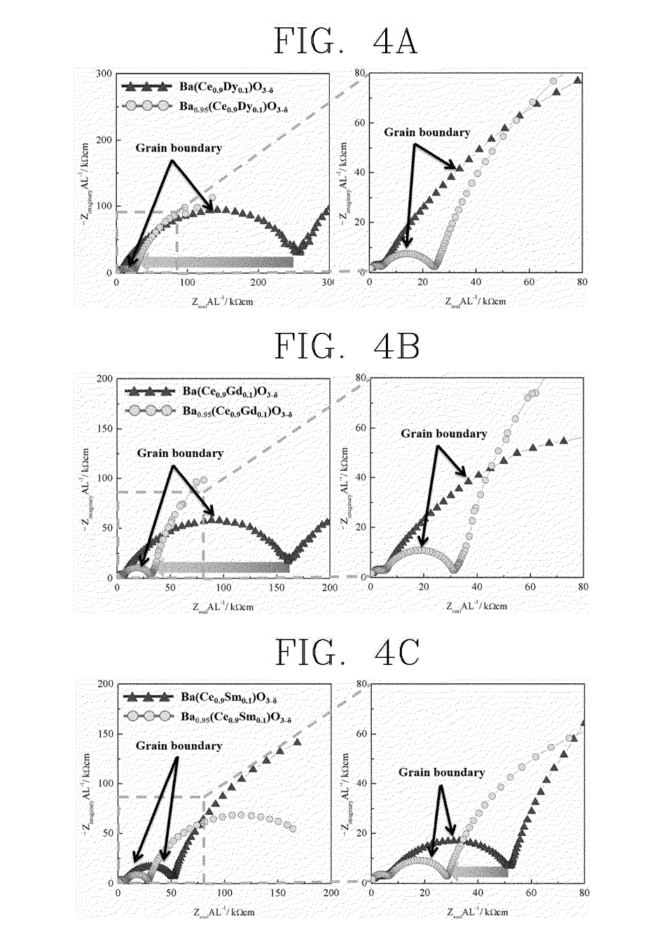

FIGS. 4A, 4B, 4C, and 4D are graphs illustrating the impedance results exhibiting an effect of decreasing the resistance of the grain boundary, which is measured in Example 1.

Hereinafter, an impedance analysis was performed in order to prove effects of the presence and absence of an amorphous layer on the proton conductivity at the grain boundary. The impedance analysis will be described in detail through Test Example 1.

### (Test Example 1) (Impedance Analysis)

An impedance analysis method used to confirm the effects of decreasing the grain boundary resistance, which a proton conductive polycrystalline oxide manufactured by a method of adjusting the composition suggested by the present invention has will be described.

The impedance analysis method is a method of measuring an impedance (Z) by applying minute alternating current signals having different frequencies to a sample. The portion in the bulk and the portion at the grain boundary have dielectric constant values different from each other, thereby exhibiting impedance results in different frequency bands. In general, a high frequency band indicates a resistance value of bulk, and a low frequency band indicates a resistance value of grain boundary. The impedance analysis result may be exhibited through a Nyquist plot, and the Nyquist plot is an imaged graph by taking a real value of the impedance resistance measured as the x-axis and a negative number of the imaginary value as the y-axis. The Nyquist plot shows the resistance value in each region in the form of a semicircle, and has an advantage in that the first semicircle being the highest frequency region shows a resistance value in the bulk, the next semicircle shows a resistance value at the grain boundary, and as a result, only the resistance at the grain boundary can be separately measured. The impedance analysis method can separate the resistance of the particle and the grain boundary as follows, and thus is an analysis method capable of providing important information in the study of analyzing resistance characteristics of a polycrystalline oxide.

In order to confirm the resistance reduction effect at the grain boundary, sintered samples of barium cerate (BaCe_{0.9}Dy_{0.1}O_{3-δ}) to which 10 mol % of Dy was added as an acceptor and barium cerate (Ba_{0.95}Ce_{0.9}Dy_{0.1}O_{3-δ}) to which the same amount of the same acceptor was added and in which only the composition of Ba was adjusted were manufactured. For an exact comparison, sintering was equally performed at the same temperature of 1,400° C. for 5 hours, a sample with a square of 10 mm×10 mm side and a thickness of 0.7 mm was prepared, a Pt paste was applied on both surfaces thereof, and an impedance analysis sample was manufactured through a heat treatment.

FIG. 4A shows Nyquist plot results of BaCe_{0.9}Dy_{0.1}O_{3-δ} and Ba_{0.95}Ce_{0.9}Dy_{0.1}O_{3-δ} measured at 200° C. The graph on the right side in FIG. 4A shows an enlarge view of the left image. When the x-axis value of the second arc, which shows the grain boundary resistance in the Nyquist plot, is measured, it can be confirmed that a grain boundary resistance value, which is 266 kΩcm before adjusting the composition, becomes 20.7 kΩcm after adjusting the composition, which is decreased by about 13 folds.

As described above, when the composition of Ba is appropriately adjusted in the present invention, the resistance value at the grain boundary is significantly decreased, thereby experimentally proving that the proton conductivity is increased. The significant decrease in resistance value can be seen to prove that the amorphous layer present at the grain boundary becomes a resistance component in the movement of protonic defects, and to prove that the removal of the amorphous layer by adjusting Ba serves to improve the proton conductivity very positively.

FIG. 4B shows the Nyquist plot results of BaCe_{0.9}Gd_{0.1}O_{3-δ} and Ba_{0.95}Ce_{0.9}Gd_{0.1}O_{3-δ} measured at 200° C., FIG. 4C shows the Nyquist plot results of BaCe_{0.9}Sm_{0.1}O_{3-δ} and Ba_{0.95}Ce_{0.9}Sm_{0.1}O_{3-δ} measured at 200° C., and FIG. 4D shows the Nyquist plot results of BaCe_{0.9}Y_{0.1}O_{3-δ} and Ba_{0.95}Ce_{0.9}Y_{0.1}O_{3-δ} measured at 200° C.

FIG. 4A shows the grain boundary resistance value decreased after adjusting the composition, and it was confirmed that the method of adjusting the composition could improve the proton conductivity in the polycrystalline oxide regardless of the type of acceptor through an additional experiment.

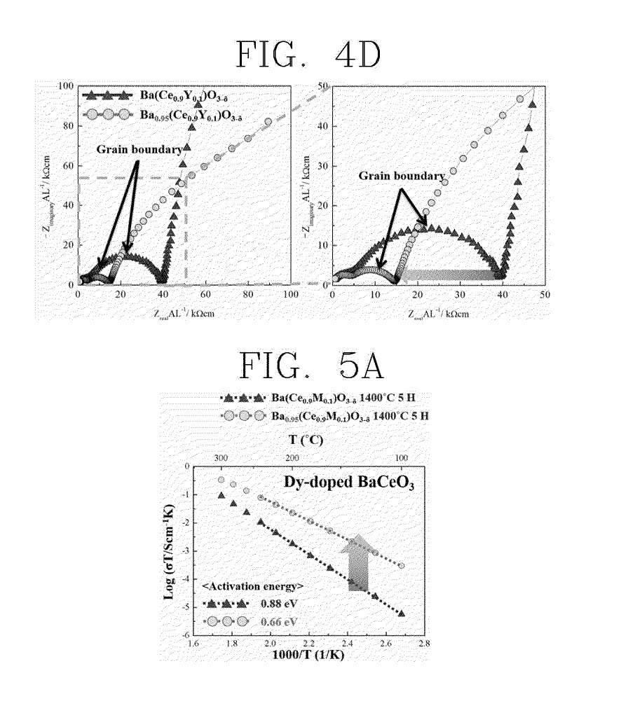

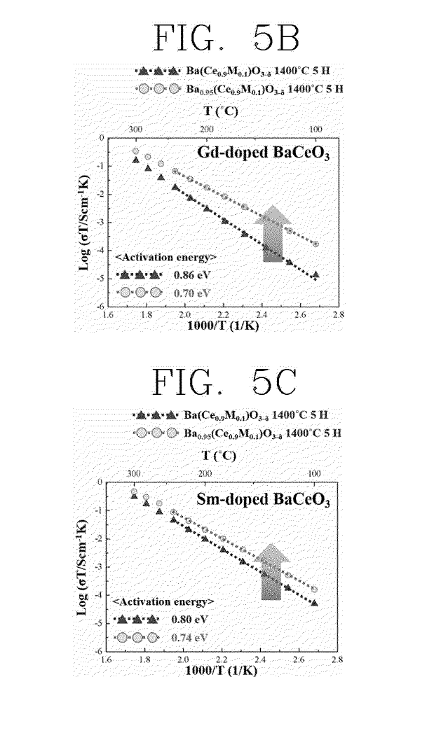

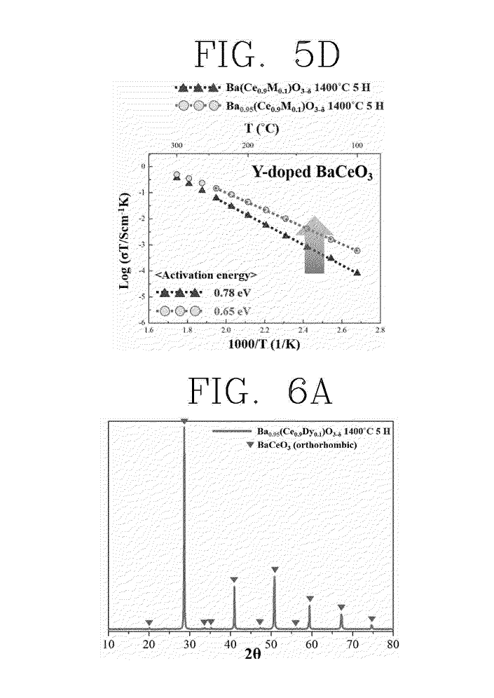

FIGS. 5A, 5B, 5C, and 5D are Arrhenius graphs illustrating an effect of decreasing the barrier energy analyzed before and after adjusting the composition in Analysis Example 2.

### (Analysis Example 2) (Arrhenius Analysis)

Analysis Example 2 shows a result of analyzing a barrier energy (activation energy, Ea) value of the movement of protonic defects by using the resistance value at the grain boundary, which is obtained based on the impedance result performed in Test Example 1. The Arrhenius graph is an equation showing the relationship among the conductivity, the absolute temperature, and the barrier energy, and may be expressed as follows.

$$σ T \approx exp ( - \frac{{E}_{a}}{kT} )$$

The Arrhenius graph has an advantage in that the barrier energy value may be obtained through the proton conductivity values measured at various temperatures. If the reciprocal number term of the absolute temperature is shown as the x-axis and the logarithmic value of the product of the proton conductivity and the absolute temperature is shown as the y-axis, the barrier energy value may be obtained via the slope.

FIG. 5A shows the Arrhenius graph of BaCe_{0.9}Dy_{0.1}O_{3-δ} and Ba_{0.95}Ce_{0.9}Dy_{0.1}O_{3-δ} and the barrier energy value in each case. When the barrier energy value of a sample manufactured with a general composition is compared with the barrier energy value of a sample in which the composition is adjusted, it can be confirmed that the barrier energy value is decreased from 0.88 eV to 0.66 eV. The following results show that the decrease in grain boundary resistance does not result from other factors such as a change in grain boundary size or composition, but the movement of protonic defects is unrestrained, and as a result, the conductivity is improved.

FIG. 5B shows the Arrhenius graph of BaCe_{0.9}Gd_{0.1}O_{3-δ} and Ba_{0.95}Ce_{0.9}Gd_{0.1}O_{3-δ} and the barrier energy value in each case, FIG. 5C shows the Arrhenius graph of BaCe_{0.9}Sm_{0.1}O_{3-δ} and Ba_{0.95}Ce_{0.9}Sm_{0.1}O_{3-δ} and the barrier energy value in each case, and FIG. 5D shows the Arrhenius graph of BaCe_{0.9}Y_{0.1}O_{3-δ} and Ba_{0.95}Ce_{0.9}Y_{0.1}O_{3-δ} and the barrier energy value in each case. As in FIG. 5A, it is possible to confirm an improved proton conductivity value and a decreased barrier energy value at the grain boundary after adjusting the composition.

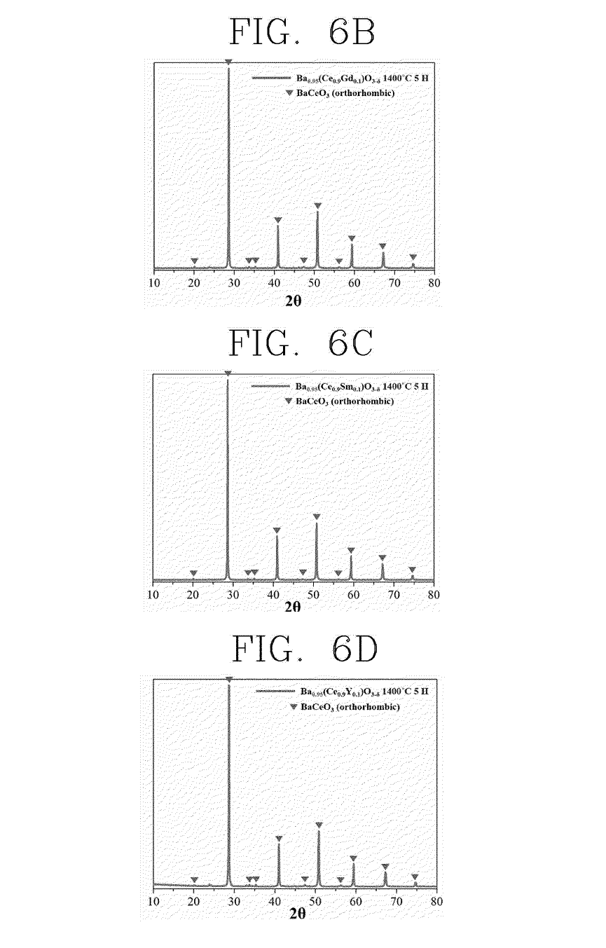

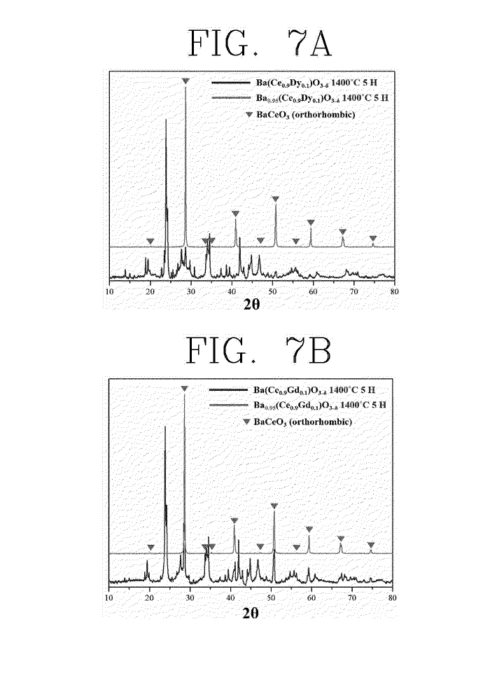

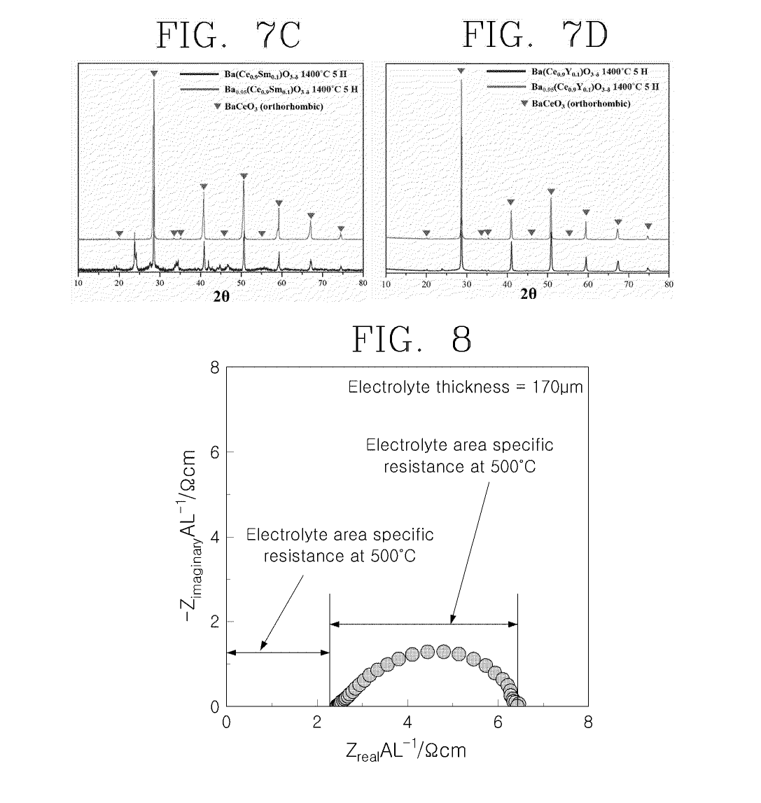

FIGS. 6A, 6B, 6C, and 6D are graphs illustrating XRD results measured after a chemical stability test of the polycrystalline oxides whose composition are adjusted, in materials to which 10 mol % of Dy, Gd, Sm, and Y are added, respectively with respect to CO₂, and FIGS. 7A, 7B, 7C, and 7D are graphs illustrating XRD results measured after a chemical stability test of the oxides whose composition is adjusted and is not adjusted, in materials to which 10 mol % of Dy, Gd, Sm, and Y are added, respectively with respect to H₂O.

### (Test Example 2) (Chemical Stability Analysis)

Test Example 2 includes effects of removal of the amorphous layer at the grain boundary occurring by adjusting the composition on the chemical stability of the proton conducting polycrystalline oxide.

It is known that barium cerate to which an acceptor is added is reacted with carbon dioxide and water as in the following Equation, and as a result, the performance deteriorates due to barium carbonate (BaCO₃) and barium hydroxide (Ba(OH)₂) produced (Ryu, K. H. & Haile, S. M. Chemical stability and proton conductivity of doped BaCeO₃—BaZrO₃ solid solutions. Solid State Ionics 125, 355-367 (1999)).

BaCeO₃+CO₂→BaCO₃+CeO₂

BaCeO₃+H₂O→Ba(OH)₂+CeO₂

In order to measure the chemical stability of a barium cerate polycrystalline oxide having no amorphous layer at the grain boundary, in which the composition is adjusted according to the present invention, the phase stability was confirmed at high temperature where carbon dioxide is supplied. In order to test the chemical stability in an environment severer than 400° C. to 600° C. which is an operation temperature of PCFC, a heat treatment was performed at 800° C. for 72 hours while being supplied with carbon dioxide, and thereafter, the chemical stability against carbon dioxide may be confirmed through XRD analysis. Further, in order to confirm the chemical stability against water, the chemical stability was tested in distilled water at 85° C. for 3 hours, and then the XRD analysis experiment was performed, and as a result, it could be confirmed that the phase of BaCeO₃ was maintained in the polycrystalline oxide having an adjusted composition, suggested by the present invention.

FIGS. 6A, 6B, 6C, and 6D are XRD results of the samples in which barium cerate to which Dy, Gd, Sm, and Y are added as an acceptor are each subjected to heat treatment at 800° C. for 72 hours while being supplied with carbon dioxide. It could be confirmed that a high chemical stability was exhibited from a sample in which the amorphous layer at the grain boundary was removed by the method of adjusting the composition through XRD analysis. In the case where the degree of the phase maintained is quantitatively shown, when the peak intensity at about 29° being a position of the main peak of BaCeO₃ is defined as 100%, the peak intensity at about 24° being a position of the main peak of BaCO₃ is shown to be smaller than 0.1%. In addition, when the relative contents of BaCeO₃ and BaCO₃ are compared to each other by using a reference intensity ratio (RIR) quantitative analysis program from the measured XRD experimental result values, it could be confirmed that BaCO₃ was included in an amount of less than 3%.

FIGS. 7A, 7B, 7C, and 7D illustrate XRD results of barium cerate to which Dy, Gd, Sm, and Y are added as an acceptor, respectively. The blue line is an XRD result of a material having an existing composition of 1:1:3 after a chemical stability test, and the green line is an XRD result of a sample in which an amorphous layer is removed from the grain boundary by the method of adjusting the composition after a chemical stability test. It can be confirmed that in the case of the material having a composition of 1:1:3, the phase is completely decomposed, and as a result, an XRD peak in which BaO, CeO₂, Ba(OH)₂, and the like are mixed is produced, whereas it can be confirmed that a sample manufactured by the method of adjusting the composition maintains an orthorhombic structure.

### (Test Example 3) (Full-Cell Test)

Test Example 3 includes the content that the impedance is measured by manufacturing a full-cell including both the electrode and the electrolyte at 500° C. in order to confirm whether the removal of the amorphous layer at the grain boundary generated by adjusting the composition is actually generated as an effect of improving the proton conductivity in an operation temperature region of the proton conductor.

At the anode and the cathode of PCFC, a reduction reaction and an oxidation reaction occur as follows.

Anode: 2H₂→4H++4e−

Cathode: O₂+4H++4e−→2H₂O

Protonic defects generated from the anode move into the electrolyte through the Grotthuss mechanism, and thus move to the cathode, and the thus reached protonic defectsare reacted with oxygen at the cathode to produce water. In the present Test Example 3, in order to confirm the performance of the proton conducting electrolyte, a full-cell test was performed by using platinum (Pt) used as a test electrode of the anode and the cathode.

A Ba_{0.95}(Ce_{0.9}Sm_{0.1})O_{3-δ} polycrystalline oxide sintered body to which Sm was added as an acceptor, which was prepared by the method of adjusting the composition suggested by the present invention was ground to 170 μm, and then electrodes were produced at the anode and the cathode by using a pulsed laser deposition (PLD) method. FIG. 8 illustrates an impedance result measured by exposing the anode and the cathode to a wet H₂ gas and the air, respectively in a full-cell manufactured by the next method. At the center of the intersection point with the X-axis, the left part indicates a resistance value generated by the electrolyte, and the right part indicates a resistance value generated by the electrode. By using a resistance value of the electrolyte measured by the next experiment, the proton conductivity of the entire electrolyte could be calculated, and it could be confirmed that the value was 7×10⁻³ S/cm.

Representative exemplary embodiments of the present invention have been described in detail, but it is to be understood by a person with ordinary skill in the art to which the present invention pertains that various modifications are possible in the above-described embodiment within the range not departing from the scope of the present invention. Therefore, the right scope of the present invention should not be defined by being limited to the described embodiments, and should be defined by not only the claims to be described below, but also those equivalent to the claims.

What is claimed is:

1. A polycrystalline oxide having the following chemical formula as an oxide of a perovskite structure and having an improved grain boundary proton conductivity:
[Chemical Formula] A₁₋ₓB_{1-y}M_{y}O₃
wherein, A is an element having a valence of 2+, B is an element having a valence of 4+, M is an element having a valence of 3+, 0<x≤0.1, and 0<y≤0.2.

2. The polycrystalline oxide of claim 1, wherein A is any one element selected from barium (Ba) and strontium (Sr), or a mixture to which these elements are added.

3. The polycrystalline oxide of claim 1, wherein B is any one element selected from cerium (Ce), zirconium (Zr), and praseodymium (Pr), or a mixture thereof.

4. The polycrystalline oxide of claim 1, wherein M is any one element selected from scandium (Sc), gallium (Ga), yttrium (Y), indium (In), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu) or a mixture thereof.

5. The polycrystalline oxide of claim 1, wherein the polycrystalline oxide has a grain boundary structure in which an amorphous layer is removed.

6. The polycrystalline oxide of claim 1, wherein the polycrystalline oxide has a barrier energy (activation energy) value of 0.65 eV or more caused by proton conduction.

7. The polycrystalline oxide of claim 1, wherein the polycrystalline oxide has a proton conductivity of 7×10⁻³ S/cm or more at 500° C.

8. The polycrystalline oxide of claim 1, wherein the polycrystalline oxide comprises BaCO₃ in an amount of less than 3% when being reacted with carbon dioxide or water.
